(19) United States
(12) Patent Application Publication
(10) Pub. No.: US 2013/0291946 A1
(43) Pub. Date: Nov. 7, 2013

(54) VALVE WITH ACTUATOR

(71) Applicant: Terry Glenn Young, Longview, TX (US)

(72) Inventor: Terry Glenn Young, Longview, TX (US)

(21) Appl. No.: 13/465,849

(22) Filed: May 7, 2012

(51) Int. Cl. F16K 31/126; F16K 3/30

(52) U.S. Cl. 137/1; 251/12; 251/64; 251/301; 137/15.23

(57) ABSTRACT

The current invention relates generally to valves and actuators. This invention further relates to valves where the phenomenon known as “slamming” is completely mitigated and/or eliminated through self-damped valve assemblies. Additionally, this invention relates to valves having an actuator assembly capable of self-damping. Further, this invention also relates to valves that are capable of being externally adjusted without disassembling or removing any of the valve structure.

### FIELD

The disclosure relates to valves and actuators. More specifically, the disclosure relates to valves having an actuator assembly capable of self-damping. The disclosure further relates to actuators which are capable of being adjusted without removal of the valve structure.

### BACKGROUND

A valve is a device that regulates the flow of a substance. Valves are produced in a variety of different styles, shapes and sizes. Typically, valves are used for gases and liquids. However, valves are also used on solids capable of flow, slurries or any other substance capable of flow. Valves are used in almost every industry having a substance that flows.

One type of valve is a gate valve, also referred to as a sluice valve. A gate valve opens by moving a blocking element from the path of flow. The blocking element may be a round disk, a rectangular element, or a wedge. Gate valves have a blocking element and a seat forming a substantially leak proof seal. In a gate valve, the blocking element can be referred to as a gate valve block, a gate block or a block. In the open position, a gate valve has a bore where the substance is allowed to partially or completely flow through the valve. In a gate valve, the bore may be referred to a gate valve bore. When the gate valve bore is across the valve bore the gate valve is in an open position. When the gate valve block is across the valve bore, the gate valve is in a closed position.

Gate valves may be operated manually or automatically. One method to automatically operate a gate valve is to use an actuator. An actuator is a mechanical device for moving or controlling a mechanism or system. When an actuator is used in a gate valve, the actuator is typically linked to a stem to repeatedly move the valve gate between open and closed positions.

Actuators to open and close the gate valves may include manual operators, diaphragm-type operators, pneumatic operators and hydraulic operators. Often, a manual operator is combined with a manual operator with a diaphragm-type, pneumatic or hydraulic operator for back-up and test purposes. Additionally, the actuator may include a bonnet assembly, which interconnects the valve body and the valve gate, and a bonnet stem which is movable with the gate via an operator.

Pneumatic actuators are often used to move a gate valve which in under pressure such as is often the case with a pneumatic gate valve used on a compressed gas line. However, when the pneumatic gate valve is under pressure, any sudden decrease in pressure across the gate may result in the system seeking rapid pressure equalization such as in the case when the gate valve moves from a closed position to an open position. This rapid pressure equalization can result in the gate valve quickly moving to the open position thus causing the stored control pressure energy of the pneumatic actuator to be rapidly released. The rapid opening of the gate valve and the release of pressure energy from the pneumatic actuator can cause the gate valve to slam open causing damage to the valve components and physically impacting both the actuator and bonnet. Rapid opening of the gate valve can be mitigated somewhat by the use of hydraulic dampeners to limit the speed with which the stem and gate can move from the closed position to the open position.

Additional issues with gate valves exist. One issue is the requirement that the valve housing be pressurized. In such designs, the internal pressure may be significantly greater than atmospheric pressure. Accordingly, any damage to the housing may compromise the structural integrity of the housing. This may cause a rupture, thus injuring equipment and personnel.

Another issue with gate valves is the alignment of the gate valve bore with the bore of the valve body, as the valve moves out of alignment with the bore of the valve body over time. This misalignment will require personnel to disassemble parts of the actuator or bonnet assembly and either insert or remove drift spacers or shims until the proper alignment is achieved. Proper alignment is necessary as the American Petroleum Institute specifies that all wellhead gate valves must be of a “through conduit” design, and must be capable of passing a dimensionally specified drift mandrel through the gate valve bore when the valve is in operable condition.

Because of these issues, maintenance and repair of gate valves can cost both money and time. In typical systems, a large portion of the valve assembly must be disassembled in order to make repairs. Additionally, the cyclical movement of actuators can cause wear on certain parts.

Accordingly, what is needed is an actuator and gate valve capable of overcoming these obstacles.

### SUMMARY

In general, the various embodiments of the present invention pertain to a fluid control apparatus comprising for opening and closing gate valves. Various embodiments of the present invention generally relate to a fluid control apparatus comprising a valve and an actuator, with the actuator positioned to exert a force to move the valve between a closed position and an open position, wherein a fluid is able to flow when the valve is in the open position, the actuator having a distal end oriented away from the valve and a proximal end oriented towards the valve. The fluid control apparatus additionally comprises a pneumatic assembly nested between the distal end of the actuator and a pneumatic lower plate; a spring assembly nested between the pneumatic lower plate and the proximal end of the actuator; and a lower spring plate abutting the proximal end of the pneumatic lower plate. In such embodiments, the pneumatic lower plate and the lower spring plate each possess a bore, each bore aligned to receive a shaft in a longitudinal direction; and the pneumatic assembly comprises a variable piston area.

Still further in the aforementioned embodiments, the pneumatic assembly, the lower spring and the top spring plate are contained in an unpressurized housing.

Additionally, in certain embodiments the fluid control apparatus possesses at least two dampener rods, each of the dampener rods nested between the lower spring plate and the proximal end of the actuator, and wherein the rods are oriented in a longitudinal direction.

In specific embodiments of the fluid control apparatus concerning the pneumatic assembly, the pneumatic assembly comprises: a diaphragm; a pneumatic conduit in fluid connection with the diaphragm; a pressure relief valve in fluid connection with the diaphragm; and wherein an external source provides pneumatic pressure to pressurize or depressurize the diaphragm through a pneumatic feed line.

Still further, in certain embodiments, the fluid control apparatus comprises an adjustable downstop, wherein the lower spring plate and the adjustable downstop are separated by a distance when the diaphragm is depressurized; and wherein the adjustable downstop is connected to an actuator lower plate. In such embodiments, rotating the actuator lower plate in relation to the adjustable downstop in one direction increases the distance between the adjustable downstop and the lower spring plate and rotating the downstop in another direction decreases the distance between the adjustable downstop and the lower spring plate. Still further, in such embodiments, the adjustable downstop has at least one adjusting port which is externally accessible.

In further embodiments of the fluid control apparatus, the apparatus additionally comprises a shaft defining a longitudinal axis and extending from a top plug at the distal end of the actuator and extending through the downstop, the shaft having a flange proximal to the pneumatic lower plate and having a flange below the downstop. In such embodiments, the shaft moves in a proximal direction when the pneumatic assembly is pressurized and moves in a distal direction when the pneumatic assembly is depressurized. Still further, the shaft may comprise a top stem and an operator stem. In such embodiments, the proximal end of the shaft may be connected to valve disposed in a fluid conduit with a defined diameter, the valve having a substantially similar fluid conduit with a substantially similar defined character.

In embodiments of the fluid control apparatus concerning the valve, the valve may be a gate valve having a gate and a block.

Other embodiments of the invention pertain to a method of opening or closing a gate valve of the fluid control apparatus of claim of one of the aforementioned embodiments, the method comprising: supplying an external pneumatic source to the pneumatic conduit; wherein the pneumatic assembly becomes pressurized and pushes the shaft in a proximal direction toward the valve; or removing an external pneumatic source to the pneumatic conduit, wherein the pneumatic assembly becomes depressurized and the spring pushes pulls the shaft in a distal direction away from the valve.

Additional embodiments of the invention pertain to a method of adjusting valve bore drift comprising: adjusting a valve assembly, the valve assembly having at least one external accessible adjusting port; an adjustable downstop connected to an actuator lower plate, the downstop having an external accessible adjusting port and a position securing device; a gate valve having a gate valve bore; and, a valve body having a valve bore. The method further comprises inserting a mechanical device in the adjusting port; and applying force with the mechanical device to move the adjustable downstop relative to the actuator lower plate, between a first position that moves the gate valve bore in an upward direction and a second position that moves the gate valve bore in a downward direction, wherein the movement of the adjustable downstop relative to the actuator lower plate causes the gate valve bore to adjust relative to a valve bore.

Still further, in certain embodiments, the method further comprises securing the adjustable downstop using a position locking device.

In additional embodiments, the method further comprises measuring a position of the gate valve bore relative to the valve bore.

In embodiments involving the method of adjusting valve bore drift, the method may involve the use of an actuator comprising: a valve; an actuator positioned to exert a force to move the valve between a closed position and an open position, wherein a fluid is able to flow when the valve is in the open position, the actuator having a distal end oriented away from the valve and a proximal end oriented towards the valve; a pneumatic assembly nested between the distal end of the actuator and a pneumatic lower plate; a spring assembly nested between the pneumatic lower plate and the proximal end of the actuator; a lower spring plate abutting the proximal end of the pneumatic lower plate, wherein the pneumatic lower plate and the lower spring plate each possess a bore, each bore aligned to receive a shaft in a longitudinal direction; and wherein the pneumatic assembly comprises a variable piston area.

In such embodiments, the method may further comprise securing the adjustable downstop using the position securing device.

Additionally, when the method pertains to applying force with the mechanical device to move the adjustable downstop relative to the actuator lower plate, such movement may comprise rotating the adjustable downstop relative to the actuator lower plate.

### BRIEF DESCRIPTION OF THE DRAWINGS

FIG. 1 is a cross-section of one embodiment of the device with actuator and external adjustment of the present invention shown in an open position.

FIG. 2 is a cross-section of one embodiment of the device shown in a closed position.

FIG. 3 is an external view of one embodiment of the device.

### LIST OF REFERENCE NUMERALS

valve assembly 10
protective housing 12
actuator lower plate 16
operator stem 20
pneumatic assembly 30
lower spring assembly 50
adjustable downstop 70
valve bonnet 90
valve gate assembly 100
valve body 110
top plug shelf 13
top plug assembly 14
top stem 22
mounting point 15
connective devices 18
operator stem 20
threaded joint 23
upper flange 25
lower flange 27
lower stem threaded connector 28
pneumatic upper plate 34
pneumatic lower plate 36
spring bolts 40
lower spring plate 52
threaded central bore 53
outer diameter threads 21
lower spring retainer plate 64
dampener rods 58
lower portion of the dampener rods 60
upper portion of the dampener rods 56
pneumatic conduit 38
pneumatic feed line 41
pressure relief valve 44
through bolts 60
downstop threaded joint 72
threaded opening 78
external adjustment ports 74
positional securing device 76
bonnet ledge 92
packing retainer 93
bonnet well 97
valve bore 114
valve body lower well 116
gate bore 104

### DETAILED DESCRIPTION

Introduction

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings making apparent to those skilled in the art how the several forms of the invention may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3rd Edition.

Various embodiments of the disclosure pertain to apparatuses for fluid control. A fluid control apparatus may comprise an actuator assembly, having a valve and an actuator.

In one embodiment of the invention, an actuator assembly may comprise a valve, a pneumatic assembly, a lower spring assembly, an actuator lower plate and an adjustable downstop. In such an embodiment, the pneumatic assembly may rest on a pneumatic lower plate, and the lower spring assembly may be positioned between the lower spring plate and the actuator lower plate. Still further, the adjustable downstop may be positionally connected to the actuator lower plate.

In another embodiment of the invention, the actuator pneumatic upper plate may be connected to the actuator lower plate with the adjustable downstop positionally connected to the actuator lower plate.

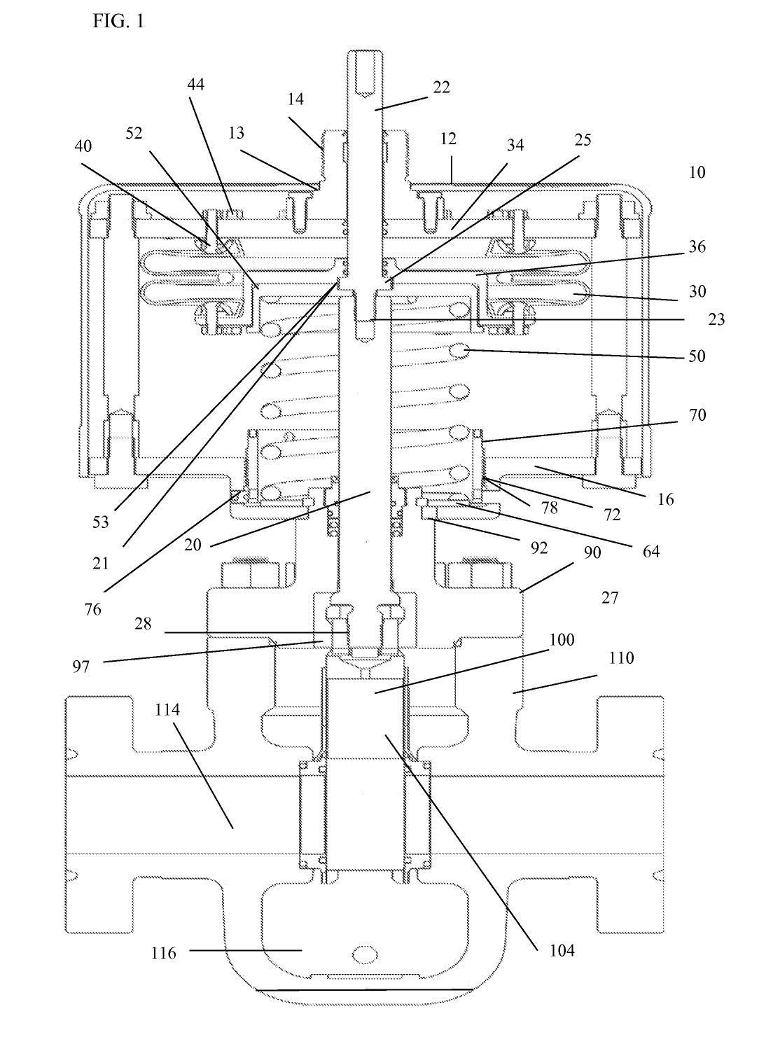

Referring to the drawings, and more particularly, FIG. 1, a valve assembly 10 is represented in an open position, wherein the valve assembly 10 comprises a protective housing 12, actuator lower plate 16, operator stem 20, pneumatic assembly 30, lower spring assembly 50, adjustable downstop 70, valve bonnet 90, valve gate assembly 100 and valve body 110.

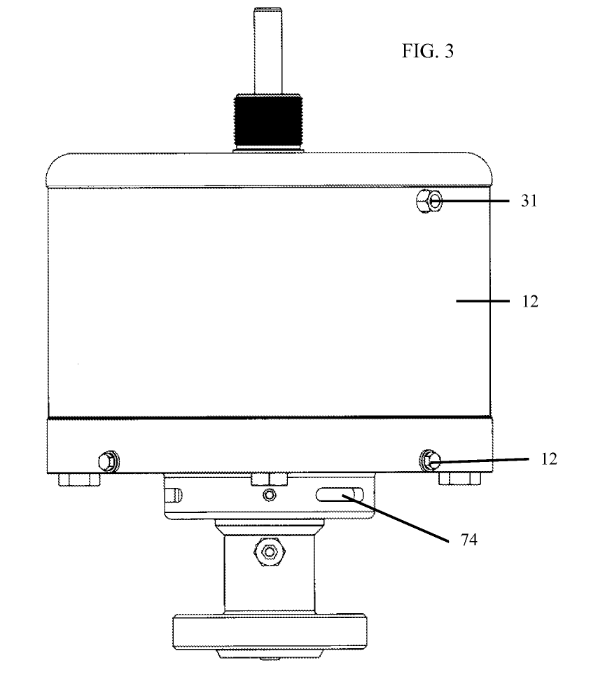

FIG. 1 shows protective housing 12 positioned on top plug shelf 13 which is located on top plug assembly 14. Top stem 22 is slidably disposed through the center of top plug assembly 14. FIG. 3 shows protective housing 12 as part of valve assembly 10 and affixed at mounting point 15 located on actuator lower plate 16 using connective devices 18. Protective housing 12 may be affixed at any mounting point on valve assembly 10 that does not interfere with valve assembly operations. Protective housing 12 may be affixed by any means known to those skilled in the art such as bolts, screws, pegs and the like. Protective housing 12 is removable without affecting the function or performance of valve assembly 10. Protective housing 12 is preferably made out of high-strength polyethylene, but any high density thermoplastic material, metal or metal compound will provide the same protective function and prevent ultraviolet ray damage to the underlying components. An advantage of using high-strength polyethylene is that is recyclable.

One advantageous characteristic of protective housing 12 is the ability for it to function as a protective shield, preventing damage to pneumatic assembly 30 and lower spring assembly 50. If structural damage does occur to protective housing 12, the protected inner components are not affected and will continue to function. Non-limiting examples of potential damage to protective housing 12 may be from weather, animals or during wellhead assembly. Personnel safety is enhanced because protective housing 12 is not pressurized, and thus poses no danger of rupture or risk of injury to nearby personnel.

FIG. 1 illustrates the interaction between top stem 22 and operator stem 20. Top stem 22 is preferably rigidly affixed to operator stem 20 at threaded joint 23. However, it is anticipated that any connector capable of rigidly affixing top stem 22 and operator stem 20 will perform satisfactorily in this invention so long as the connector does not prohibit fully opening or closing the valve. Even though the invention is described as comprising a top stem 22 and an operator stem 20, it is anticipated that the top stem 22 and the operator stem 20 will function in an equivalent manner when formed out of a single element.

Top stem 22 is slidably disposed through top plug assembly 14 and pneumatic lower plate 36. Top stem 22 has upper flange 25 positioned above threaded joint 23.

Operator stem 20 is slidably disposed through adjustable downstop 70, and valve bonnet 90. Operator stem 20 has lower flange 27 positioned above lower stem threaded connector 28. Lower stem threaded connector 28 is rigidly affixed to gate valve assembly 100.

Referencing FIG. 1, distal to the pneumatic assembly 30 is preferably a pneumatic upper plate 34. Proximal to the pneumatic assembly 30 is a pneumatic lower plate 36. The pneumatic assembly is preferably affixed to the pneumatic upper plate 34 and the pneumatic lower plate 36 via spring bolts 40. Pneumatic assembly 30 will operate without being affixed to either pneumatic upper plate 34 or pneumatic lower plate 36. Also, pneumatic assembly 30 will operate with only the pneumatic upper plate 34 affixed or pneumatic lower plate 36 affixed.

Pneumatic lower plate 36 is affixed to top shaft 22 distal to the upper flange 25. At least some portion of upper flange 25 fits within the pneumatic lower plate 36 without any impingement.

Lower spring plate 52 of the lower spring 50 preferably has a threaded central bore 53. The top stem 22, distal to the upper flange 25 may have outer diameter threads 21. Although the threaded central bore 53 and the outer diameter threads 21 are shown as a threaded engagement, any connective means providing similar rigidity will work as an acceptable substitute.

Distal to, and in fluid connection with the lower spring 50 is a lower spring plate 52. Proximal to, and in fluid connection with the lower spring 50 is a lower spring retainer plate 64, which rests within the proximal portion of the threaded downstop 70.

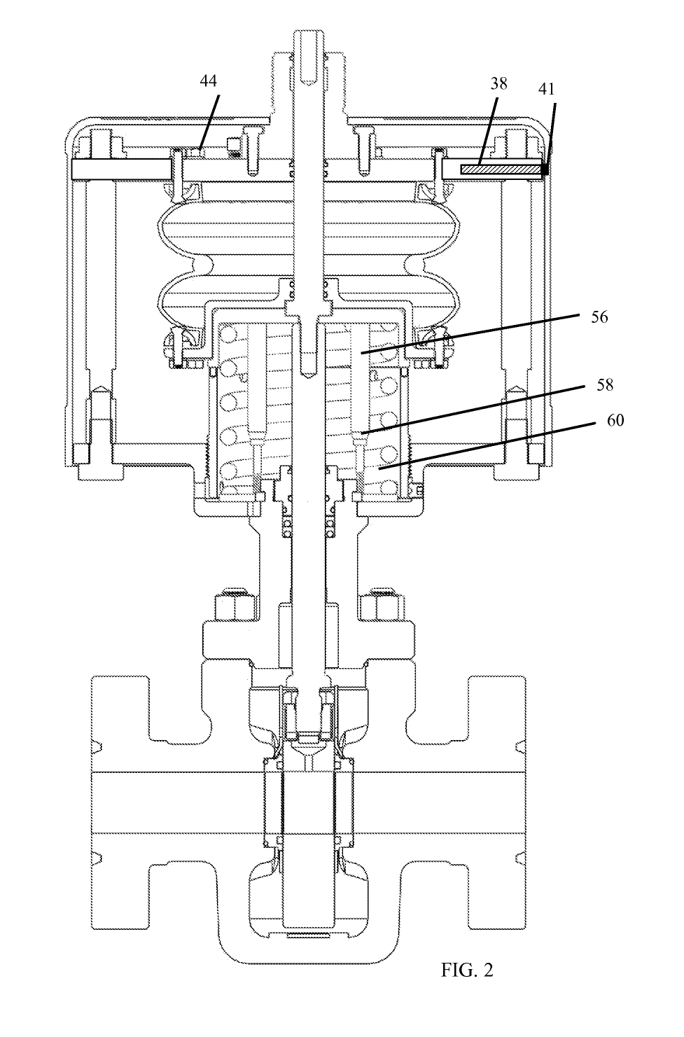

As illustrated in FIG. 2, dampener rods 58 fit within the inner circumference of the lower spring and connect the lower spring plate 52 with the lower spring retainer plate 64. Dampener rods 58 can be collapsible such that when the lower spring is in a compressed position, the rods themselves collapse with the lower portion of the dampener rods 60 entering the upper portion of the dampener rods 56. The dampener rods can be bolted, welded or otherwise affixed to the lower spring plate and the lower spring retainer plate as needed. In alternative models, the dampener rods can be reversed in position such that the lower portion of the dampener rods is distal to the upper portion of the dampener rods 56. Although FIG. 2 is a cross sectional illustration, more than two dampener rods may be used in the actuator. For example, 3, 4, 5, 6, 7, 8, 9, 10 or more dampener rods may be positioned within the spring and between the lower spring plate and the lower spring retainer plate. The dampener rods serve to prevent slamming upwards or distal from the gate valve when pressure is removed from the pneumatic assembly 30. Alternatively, the dampener rods can prevent slamming downwards or towards the gate valve when pressure is supplied to the pneumatic assembly.

In practical application, the dampener rods act as a shock absorption system. Upon pressurization of the pneumatic assembly 30, the dampener rods contract and provide some resistance against the downward or proximal force of the now pressurized assembly. Likewise, upon depressurization of the pneumatic assembly 30 the dampener rods provide resistance to keep the lower spring 50 from causing the top stem 22 from slamming upwards with great force.

FIG. 2 more particularly illustrates the pneumatic action of the actuator. In this embodiment, pneumatic upper plate 34 has a pneumatic conduit 38 connected to pneumatic feed line 41. Pneumatic conduit 38 connects with a pneumatic post which would penetrate the pneumatic upper plate 34. The combined linkage of pneumatic feed line 41, pneumatic conduit 38 and a pneumatic post provides pneumatic pressure to the pneumatic assembly 30 from an external source. Pressure relief valve 44 is shown affixed to and penetrating pneumatic upper plate 34. Through bolts 60 connect the pneumatic upper plate 34 to the lower actuator plate 16. This may result in increased stability of the actuator.

Preferably as in FIG. 1, adjustable downstop 70 is adjustably connected to actuator lower plate 16 at downstop threaded joint 72. Preferably, actuator lower plate 16 has a threaded opening 78. Downstop threaded joint 72 may be referred to as a second receiver positioned on adjustable downstop 70. In the preferred embodiment, adjustable downstop 70 is movable by rotating upward or downward within the threads of downstop threaded joint 72. Movement of adjustable downstop 70 in a first direction pulls actuator lower plate 16 in an upward direction. Movement of adjustable downstop 70 in a second direction pushes actuator lower plate 16 in a downward direction. The upward or downward movement of actuator lower plate 16 causes lower spring assembly 50 to compress or decompress.

Adjustable downstop 70 is externally accessible through external adjustment ports 74 shown in FIG. 3. External adjustment ports 74 are accessible without having to remove protective housing 12. A mechanical device may be used to perform adjustments to adjustable downstop 70 through external adjustment ports 74. Once adjustable downstop 70 is positioned, it may be locked into position using a positional securing device 76, such as a set screw. (Illustrated in FIG. 1) However, positional securing device 76 may be any type of device capable of locking adjustable downstop 70 into position and preventing movement of adjustable downstop 70. The many types of devices capable of locking adjustable downstop 70 into position are known to those skilled in the art. Regardless of the type of positional securing device 76 utilized, it must be capable of being released from the locked position to allow the adjustment of adjustable downstop 70. Although downstop threaded joint 72 is discussed in terms of being threaded, it is anticipated that any connection allowing adjustable downstop 70 and actuator lower plate 16 to adjust relative to each other will be an acceptable substitute.

Referencing FIG. 1, a bonnet ledge 92 is positioned distal to the valve bonnet 90. Actuator lower plate 16 is held into position on bonnet ledged 92 by any standard means such a clip a weld forging, casting, or bolting.

Valve bonnet 90 preferably has packing retainer 93. Operator stem 20 is shown slidably disposed in packing retainer 93. Valve bonnet 90 preferably retains lower flange 27 in bonnet well 97.

Valve bonnet 90 is affixed to valve body 110. Operator stem 20 is preferably connected to valve gate assembly 100. In the preferred embodiment, operator stem 20 is threadably connected to valve gate assembly 100. However, other connective mechanisms known to those skilled in the art may be used. Valve gate assembly 100 is shown positioned across and blocking valve bore 114. Valve bore 114 is also referred to as a fluid conduit. When valve gate assembly 100 is in the closed position, all fluid is prohibited from flowing through valve bore 114. Referencing FIG. 1, valve gate assembly 100 is disposed in valve body lower well 116 and gate bore 104 is positioned across valve bore 114. When gate bore 104 and valve bore 114 are at least partially aligned, fluid is allowed to pass through the valve body 110.

### Operation of the Embodiments

To open or close the valve, a controller sends an input to a pneumatic source. In this instance, upon receiving the signal, pneumatic pressure is sent across the pneumatic line to the valve assembly 10. The pneumatic pressure causes the pneumatic assembly 30 to inflate or deflate. The expanding or inflating action causes the actuator to put force upon pneumatic lower plate 36, thus causing the pneumatic lower plate to move in a downwards or proximal direction. This action also causes movement of the top stem 22 and the operator stem 20. The movement of the operator stem 20 forces the valve gate assembly 100 to move into the valve body well 116. The gate bore 104 is now positioned across the valve bore 114 and allows flow through valve body 110. To block flow across valve bore 114, the operation is reversed.

The valve 10 is self-damping. The self-damping function is found in the pneumatic assembly 30 itself. As the pneumatic assembly 30 is inflated, the cross-sectional area of the piston is decreased. That is, the cross-sectional area decreases as the thickness, or height, of the pneumatic assembly is increased. Force is decreased as more energy is required to inflate the pneumatic assembly across a longer vertical distance, or height. This height is the piston of the pneumatic assembly. The diaphragm is self-damping as the piston exerts less force. This action continually reduces the force the pneumatic assembly 30 exerts on the plates beneath the pneumatic assembly 30 through the piston stroke. Further, a second self-damping function is from the lower spring assembly 50. As the bottom plates move, each transmits force to the top stem 22 and/or the operator stem 20 stem and to the pneumatic lower plate 36 and the lower spring plate 52. The pneumatic assembly 30 resists the force of movement. The resistance of force creates a second self-damping function for valve assembly 10. The pre-loaded spring effectively eliminates all force that the gate block will see once it impacts valve body lower well 116. The two aforementioned self-damping functions substantially mitigate the slamming effect of valve gate assembly 100 to a point that slamming is essentially eliminated.

1. A fluid control apparatus comprising:
a valve;
an actuator positioned to exert a force to move the valve between a closed position and an open position, wherein a fluid is able to flow when the valve is in the open position, the actuator having a distal end oriented away from the valve and a proximal end oriented towards the valve;
a pneumatic assembly nested between the distal end of the actuator and a pneumatic lower plate;
a spring assembly nested between the pneumatic lower plate and the proximal end of the actuator;
a lower spring plate abutting the proximal end of the pneumatic lower plate, wherein the pneumatic lower plate and the lower spring plate each possess a bore, each bore aligned to receive a shaft in a longitudinal direction; and
wherein the pneumatic assembly comprises a variable piston area.

2. The fluid control apparatus of claim 1, wherein the pneumatic assembly, the lower spring and the top spring plate are contained in an unpressurized housing.

3. The fluid control apparatus of claim 1, further comprising at least two dampener rods, each of the dampener rods nested between the lower spring plate and the proximal end of the actuator, and wherein the rods are oriented in a longitudinal direction.

4. The fluid control apparatus of claim 1, wherein the pneumatic assembly comprises:
a diaphragm;
a pneumatic conduit in fluid connection with the diaphragm;
a pressure relief valve in fluid connection with the diaphragm; and
wherein an external source provides pneumatic pressure to pressurize or depressurize the diaphragm through a pneumatic feed line.

5. The fluid control apparatus of claim 4, further comprising an adjustable downstop, wherein the lower spring plate and the adjustable downstop are separated by a distance when the diaphragm is depressurized; and wherein the adjustable downstop is connected to an actuator lower plate.

6. The fluid control apparatus of claim 5, wherein rotating the actuator lower plate in relation to the adjustable downstop in one direction increases the distance between the adjustable downstop and the lower spring plate and rotating the downstop in another direction decreases the distance between the adjustable downstop and the lower spring plate.

7. The fluid control apparatus of claim 1, wherein the adjustable downstop has at least one adjusting port which is externally accessible.

8. The fluid control apparatus of claim 5, further comprising a shaft defining a longitudinal axis and extending from a top plug at the distal end of the actuator and extending through the downstop, the shaft having a flange proximal to the pneumatic lower plate and having a flange below the downstop.

9. The fluid control apparatus of claim 8, wherein the shaft moves in a proximal direction when the pneumatic assembly is pressurized and moves in a distal direction when the pneumatic assembly is depressurized.

10. The fluid control apparatus of claim 8, wherein the shaft comprises a top stem and an operator stem.

11. The fluid control apparatus of claim 8, wherein the proximal end of the shaft is connected to valve disposed in a fluid conduit with a defined diameter, the valve having a substantially similar fluid conduit with a substantially similar defined character.

12. The fluid control apparatus of claim 11, wherein the valve is a gate valve having a gate and a block.

13. A method of opening or closing a gate valve of the fluid control apparatus of claim 12, comprising:
supplying an external pneumatic source to the pneumatic conduit; wherein the pneumatic assembly becomes pressurized and pushes the shaft in a proximal direction toward the valve; or
removing an external pneumatic source to the pneumatic conduit, wherein the pneumatic assembly becomes depressurized and the spring pushes pulls the shaft in a distal direction away from the valve.

14. A method of adjusting valve bore drift comprising:
adjusting a valve assembly, the valve assembly having:
at least one external accessible adjusting port;
an adjustable downstop connected to an actuator lower plate, the downstop having an external accessible adjusting port and a position securing device;
a gate valve having a gate valve bore; and,
a valve body having a valve bore;
inserting a mechanical device in the adjusting port; and
applying force with the mechanical device to move the adjustable downstop relative to the actuator lower plate, between a first position that moves the gate valve bore in an upward direction and a second position that moves the gate valve bore in a downward direction, wherein the movement of the adjustable downstop relative to the actuator lower plate causes the gate valve bore to adjust relative to a valve bore.

15. The method of claim 14, wherein the method further comprises securing the adjustable downstop using a position locking device.

16. The method of claim 14, wherein the method further comprises measuring a position of the gate valve bore relative to the valve bore.

17. The method of claim 14, wherein the method involves the use of an actuator comprising:
a valve;
an actuator positioned to exert a force to move the valve between a closed position and an open position, wherein a fluid is able to flow when the valve is in the open position, the actuator having a distal end oriented away from the valve and a proximal end oriented towards the valve;
a pneumatic assembly nested between the distal end of the actuator and a pneumatic lower plate;
a spring assembly nested between the pneumatic lower plate and the proximal end of the actuator;
a lower spring plate abutting the proximal end of the pneumatic lower plate, wherein the pneumatic lower plate and the lower spring plate each possess a bore, each bore aligned to receive a shaft in a longitudinal direction; and
wherein the pneumatic assembly comprises a variable piston area.

18. The method of claim 14, further comprising securing the adjustable downstop using the position securing device.

19. The method of claim 14, wherein applying force with the mechanical device to move the adjustable downstop relative to the actuator lower plate comprises rotating the adjustable downstop relative to the actuator lower plate.

20. The method of claim 19, wherein rotating the actuator lower plate in relation to the adjustable downstop in one direction increases the distance between the adjustable downstop and the lower spring plate and rotating the downstop in another direction decreases the distance between the adjustable downstop and the lower spring plate.
